(19) United States
(12) Patent Application Publication
(10) Pub. No.: US 2025/0294654 A1
(43) Pub. Date: Sep. 18, 2025

(54) LOAD REGULATION OPTIMIZATION CIRCUIT FOR WIDE-LOAD LIGHT-EMITTING DIODE (LED) DRIVER POWER SUPPLY

(71) Applicant: Wuxi Seastar Lighting Co., Ltd., Wuxi (CN)

(72) Inventors: Zhihui HUANG, Wuxi (CN); Xinrong SHA, Wuxi (CN); Jiyong LIU, Wuxi (CN)

(73) Assignee: Wuxi Seastar Lighting Co., Ltd., Wuxi (CN)

(21) Appl. No.: 19/224,006

(22) Filed: May 30, 2025

(30) Foreign Application Priority Data
Jun. 20, 2024 (CN) 202410802963.7

(51) Int. Cl. H05B 45/38; H05B 45/50

(52) U.S. Cl. CPC H05B 45/38; H05B 45/50

(57) ABSTRACT

A load regulation optimization circuit for a wide-load light-emitting diode (LED) driver power supply includes: a voltage input module configured to convert an alternating current (AC) into a direct current (DC) for output; and an input undervoltage and overvoltage protection module configured to detect a voltage condition of the voltage input module and provide a feedback to a control module. Compared with the prior art, the present disclosure has the following beneficial effects. In the present disclosure, a current compensation module is configured to feed voltage variation information back to the control module when a voltage variation occurs at an LED load due to an LED load variation. Thus, the control module changes the duty cycle of a driving output, thereby ultimately changing the output current of a voltage output module to maintain a stable current flowing through the LED load.

### CROSS-REFERENCE TO RELATED APPLICATIONS

This application claims priority to Chinese Patent Application No. 202410802963.7 with a filing date of Jun. 20, 2024. The content of the aforementioned application, including any intervening amendments thereto, is incorporated herein by reference.

### TECHNICAL FIELD

The present disclosure relates to the technical field of light-emitting diode (LED) lighting, and in particular to a load regulation optimization circuit for a wide-load LED driver power supply.

### BACKGROUND

At present, light-emitting diode (LED) lighting has seen extensive applications, creating a demand for high-efficiency and stable LED driver power supplies. Nevertheless, existing LED driver power supplies may exhibit inadequate load regulation under different load conditions, leading to substantial power errors and brightness fluctuations when selecting LED driver power supplies. Consequently, improvements to existing solutions are imperative.

### SUMMARY OF PRESENT INVENTION

An objective of the present disclosure is to provide a load regulation optimization circuit for a wide-load light-emitting diode (LED) driver power supply, in order to solve the problems mentioned in the above background section.

In order to achieve the above objective, the present disclosure provides the following technical solution:

A load regulation optimization circuit for a wide-load LED driver power supply includes:
a voltage input module, configured to convert an alternating current (AC) into a direct current (DC) for output;
an input undervoltage and overvoltage protection module, configured to detect a voltage condition of the voltage input module and provide a feedback to a control module;
a high-voltage startup module, configured to provide a startup voltage to the control module during circuit startup;
a BOOST module, configured to receive a control from the control module, boost the DC output from the voltage input module, and output a voltage to a voltage output module;
an over-power protection module, configured to detect an output power of the BOOST module and provide a feedback to the control module;
the voltage output module, configured to receive the voltage output from the BOOST module, process the voltage, and supply a DC to an LED load;
an output voltage feedback module, configured to sample a voltage of the voltage output module and provide a feedback to the control module;
a current compensation module, configured to change signal magnitude fed back to the control module when the voltage sampled by the output voltage feedback module reaches a startup value, thereby changing a duty cycle of a driving output through the control module to ultimately stabilize a current flowing through the LED load;
a power supply module, configured to provide an operating voltage for the control module; and
the control module, configured to comprehensively control circuit operation;
where, the voltage input module is connected to the input undervoltage and overvoltage protection module, the high-voltage startup module, and the BOOST module; the input undervoltage and overvoltage protection module is connected to the control module; the high-voltage startup module is connected to the control module; the BOOST module is connected to the over-power protection module, the voltage output module, and the output voltage feedback module; the over-power protection module is connected to the control module; the output voltage feedback module is connected to the control module and the current compensation module; the current compensation module is connected to the control module; and the power supply module is connected to the control module.

In a further solution of the present disclosure, the input undervoltage and overvoltage protection module includes a diode D6, a diode D8, a resistor R7, and a capacitor C8; an anode of the diode D6 is connected to the voltage input module; an anode of the diode D8 is connected to the voltage input module; a cathode of the diode D6 is connected to a cathode of the diode D8 and one terminal of the resistor R7; the other terminal of the resistor R7 is connected to one terminal of the capacitor C8 and the control module; and the other terminal of the capacitor C8 is grounded.

In a further solution of the present disclosure, the high-voltage startup module includes a resistor R3, a resistor R5, a transistor Q2, and a diode D7; one terminal of the resistor R3 is connected to one terminal of the resistor R5 and the voltage input module; the other terminal of the resistor R3 is connected to a collector of the transistor Q2; the other terminal of the resistor R5 is connected to a base of the transistor Q2 and the control module; an emitter of the transistor Q2 is connected to an anode of the diode D7; and a cathode of the diode D7 is connected to the control module.

In a further solution of the present disclosure, the BOOST module includes a transformer L1, a diode D1, a diode D2, a transistor Q1, a resistor R11, a resistor R2, a capacitor C10, a capacitor C2, a capacitor C1, a resistor R1, a diode D5, a metal-oxide-semiconductor (MOS) transistor Q4, and a resistor R12; a fourth terminal of the transformer L1 is connected to the voltage input module and an anode of the diode D1; a sixth terminal of the transformer L1 is connected to the control module through a resistor R8; a tenth terminal of the transformer L1 is grounded; a first terminal of the transformer L1 is connected to a collector of the transistor Q1 and an anode of the diode D2; an emitter of the transistor Q1 is connected to one terminal of the resistor R11 and the control module; the other terminal of the resistor R11 is grounded; a base of the transistor Q1 is connected to the control module; a cathode of the diode D1 is connected to a cathode of the diode D2, one terminal of the resistor R2, one terminal of the capacitor C2, one terminal of the capacitor C1, one terminal of the resistor R1, and a first terminal of a transformer T1; the other terminal of the resistor R2 is connected to the control module and one terminal of the capacitor C10; the other terminal of the capacitor C10 is grounded; the other terminal of the capacitor C2 is grounded; the other terminal of the capacitor C1 is connected to the other terminal of the resistor R1 and a cathode of the diode D5; an anode of the diode D5 is connected to a third terminal of the transformer T1 and a drain (D) of the MOS transistor Q4; a source (S) of the MOS transistor Q4 is connected to the over-power protection module; and a gate (G) of the MOS transistor Q4 is connected to the control module through the resistor R12.

In a further solution of the present disclosure, the over-power protection module includes a resistor R18, a resistor R13, and a capacitor C12; one terminal of the resistor R18 is connected to one terminal of the resistor R13 and the BOOST module; the other terminal of the resistor R18 is grounded; the other terminal of the resistor R13 is connected to the control module and one terminal of the capacitor C12; and the other terminal of the capacitor C12 is grounded.

In a further solution of the present disclosure, the output voltage feedback module includes a resistor R10, a resistor R16, and a capacitor C11; one terminal of the resistor R10 is connected to an anode of the diode D9 and a fourth terminal of a transformer T1; a fifth terminal of the transformer T1 is grounded; a cathode of a diode D9 is connected to one terminal of a resistor R6; the other terminal of the resistor R6 is connected to one terminal of a capacitor C7 and the current compensation module; the other terminal of the capacitor C7 is grounded; the other terminal of the resistor R10 is connected to one terminal of the resistor R16, one terminal of the capacitor C11, and the control module; the other terminal of the capacitor C11 is grounded; and the other terminal of the resistor R16 is grounded.

In a further solution of the present disclosure, the current compensation module includes a diode ZD2, a resistor R15, a transistor Q5, a transistor Q6, and a resistor R14; the diode ZD2 includes a cathode connected to the output voltage feedback module and an anode connected to one terminal of the resistor R15; the other terminal of the resistor R15 is connected to a base of the transistor Q5, a base of the transistor Q6, and a collector of the transistor Q6; an emitter of the transistor Q6 is directly grounded or grounded through a resistor; an emitter of the transistor Q5 is directly grounded or grounded through a resistor; a collector of the transistor Q5 is connected to one terminal of the resistor R14; and the other terminal of the resistor R14 is connected to the control module.

In a further solution of the present disclosure, the control module includes a chip U1, and a model of the chip U1 is IW3617 or IW3616; a pin 7 of the chip U1 is connected to the power supply module; a pin 2 of the chip U1 is connected to the input undervoltage and overvoltage protection module; a pin 6 of the chip U1 is connected to the high-voltage startup module; a pin 4 and a pin 10 of the chip U1 are connected to the BOOST module; a pin 11 of the chip U1 is connected to the over-power protection module and the current compensation module; and a pin 12 of the chip U1 is connected to the output voltage feedback module.

Compared with the prior art, the present disclosure has the following beneficial effects. In the present disclosure, the current compensation module is configured to feed voltage variation information back to the control module when voltage variations occur at the LED load due to the LED load variations. Thus, the control module changes the duty cycle of the driving output, thereby ultimately changing the output current of the voltage output module to maintain a stable current flowing through the LED load. The design prevents significant power errors and brightness fluctuations caused by output current variations during LED load variations (voltage variations at the LED load).

### BRIEF DESCRIPTION OF THE DRAWINGS

FIG. 1 is a circuit diagram showing a load regulation optimization circuit for a wide-load light-emitting diode (LED) driver power supply;

FIG. 2 is a simulated circuit diagram showing a current compensation module;

FIG. 3 is a simulated waveform diagram of the current compensation module; and

FIG. 4 is another circuit diagram of the current compensation module.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiments derived from the embodiments in the present disclosure by a person of ordinary skill in the art without creative efforts should fall within the protection scope of the present disclosure.

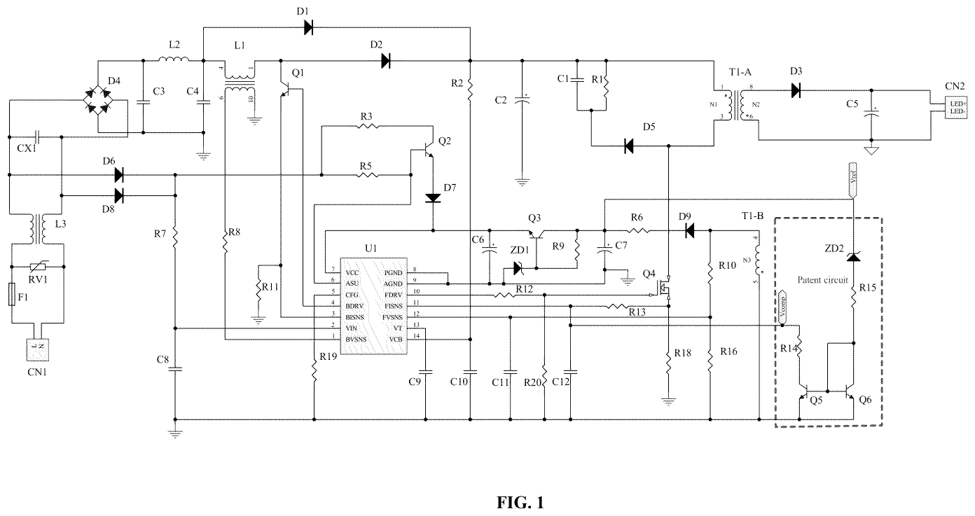

Please refer to FIG. 1. A load regulation optimization circuit for a wide-load light-emitting diode (LED) driver power supply includes:
a voltage input module, configured to convert an alternating current (AC) into a direct current (DC) for output;
an input undervoltage and overvoltage protection module, configured to detect a voltage condition of the voltage input module and provide a feedback to a control module;
a high-voltage startup module, configured to provide a startup voltage to the control module during circuit startup;
a BOOST module, configured to receive a control from the control module, boost the DC output from the voltage input module, and output a voltage to a voltage output module;
an over-power protection module, configured to detect an output power of the BOOST module and provide a feedback to the control module;
the voltage output module, configured to receive the voltage output from the BOOST module, process the voltage, and supply a DC to an LED load;
an output voltage feedback module, configured to sample a voltage of the voltage output module and provide a feedback to the control module;
a current compensation module, configured to change signal magnitude fed back to the control module when the voltage sampled by the output voltage feedback module reaches a startup value, thereby changing a duty cycle of a driving output through the control module to ultimately stabilize a current flowing through the LED load;
a power supply module, configured to provide an operating voltage for the control module; and
the control module, configured to comprehensively control circuit operation.

The voltage input module is connected to the input undervoltage and overvoltage protection module, the high-voltage startup module, and the BOOST module. The input undervoltage and overvoltage protection module is connected to the control module. The high-voltage startup module is connected to the control module. The BOOST module is connected to the over-power protection module, the voltage output module, and the output voltage feedback module. The over-power protection module is connected to the control module. The output voltage feedback module is connected to the control module and the current compensation module. The current compensation module is connected to the control module. The power supply module is connected to the control module.

In a specific embodiment, please refer to FIG. 1. In the voltage input module, an interface CN1 is an AC input terminal configured to introduce a 220 V AC. A fuse F1 provides overcurrent and short-circuit protection. A thermistor RV1 provides lightning surge protection. A common-mode choke L3 and a capacitor CX1 provide electromagnetic compatibility (EMC) common-mode filtering. A rectifier bridge D4 provides full-wave rectification. A capacitor C3, a capacitor C4, and an inductor L2 provide differential-mode filtering.

In the voltage output module, the output voltage of the BOOST module passes through a transformer T1 (specifically an input-output terminal T1-A of the transformer), is output through a diode D3 and a capacitor C5, and is delivered to the LED load via an interface CN2.

In the power supply module, a fourth terminal and a fifth terminal of the transformer T1 (specifically an auxiliary winding T1-B of the transformer) generate a voltage, which is input to a transistor Q3. At this time, a diode ZD1 conducts. The diode ZD1 provides a zener voltage to a base of the transistor Q3. The transistor Q3 conducts to supply power to the control module.

In this embodiment, please refer to FIG. 1. The input undervoltage and overvoltage protection module includes a diode D6, a diode D8, a resistor R7, and a capacitor C8. An anode of the diode D6 is connected to the voltage input module. An anode of the diode D8 is connected to the voltage input module. A cathode of the diode D6 is connected to a cathode of the diode D8 and one terminal of the resistor R7. The other terminal of the resistor R7 is connected to one terminal of the capacitor C8 and the control module. The other terminal of the capacitor C8 is grounded.

The voltage of the voltage input module is collected through the diode D6 and the diode D8, and the voltage is output to the control module via the resistor R7. When the input voltage is abnormal, the control module obtains relevant information in a timely manner.

In this embodiment, please refer to FIG. 1. The high-voltage startup module includes a resistor R3, a resistor R5, a transistor Q2, and a diode D7. One terminal of the resistor R3 is connected to one terminal of the resistor R5 and the voltage input module. The other terminal of the resistor R3 is connected to a collector of the transistor Q2. The other terminal of the resistor R5 is connected to a base of the transistor Q2 and the control module. An emitter of the transistor Q2 is connected to an anode of the diode D7. A cathode of the diode D7 is connected to the control module.

Under normal conditions, the base of transistor Q2 is at a low level. During circuit power-up, the transistor Q2 conducts, supplies power to the control module through the diode D7, and performs high-voltage startup of the control module.

In this embodiment, please refer to FIG. 1. The BOOST module includes a transformer L1, a diode D1, a diode D2, a transistor Q1, a resistor R11, a resistor R2, a capacitor C10, a capacitor C2, a capacitor C1, a resistor R1, a diode D5, a metal-oxide-semiconductor (MOS) transistor Q4, and a resistor R12. A fourth terminal of the transformer LI is connected to the voltage input module and an anode of the diode D1. A sixth terminal of the transformer L1 is connected to the control module through a resistor R8. A tenth terminal of the transformer L1 is grounded. A first terminal of the transformer L1 is connected to a collector of the transistor Q1 and an anode of the diode D2. An emitter of the transistor Q1 is connected to one terminal of the resistor R11 and the control module. The other terminal of the resistor R11 is grounded. A base of the transistor Q1 is connected to the control module. A cathode of the diode D1 is connected to a cathode of the diode D2, one terminal of the resistor R2, one terminal of the capacitor C2, one terminal of the capacitor C1, one terminal of the resistor R1, and a first terminal of a transformer T1. The other terminal of the resistor R2 is connected to the control module and one terminal of the capacitor C10. The other terminal of the capacitor C10 is grounded. The other terminal of the capacitor C2 is grounded. The other terminal of the capacitor C1 is connected to the other terminal of the resistor R1 and a cathode of the diode D5. An anode of the diode D5 is connected to a third terminal of the transformer T1 and a drain (D) of the MOS transistor Q4. A source (S) of the MOS transistor Q4 is connected to the over-power protection module. A gate (G) of the MOS transistor Q4 is connected to the control module through the resistor R12.

The control module controls a current state on the transformer L1 by controlling a conduction frequency of the transistor Q1, so as to ultimately change the voltage magnitude on the capacitor C2, and form a boost circuit. The resistor R1, the capacitor C1, and the diode D5 constitute a reflected voltage spike absorption circuit to handle a spike voltage at the transformer T1. The control module provides a driving pulse-width modulation (PWM) signal through the resistor R12 to control the conduction state of the MOS transistor Q4, regulate current flow conditions between the first terminal and the third terminal of the transformer T1, and adjust output magnitude. The transformer T1 and the MOS transistor Q4 form a flyback power conversion circuit.

In this embodiment, please refer to FIG. 1. The over-power protection module includes a resistor R18, a resistor R13, and a capacitor C12. One terminal of the resistor R18 is connected to one terminal of the resistor R13 and the BOOST module. The other terminal of the resistor R18 is grounded. The other terminal of the resistor R13 is connected to the control module and one terminal of the capacitor C12. The other terminal of the capacitor C12 is grounded.

A constant current signal is output to the control module through the resistor R13. The output condition at the transformer T1 is sampled through the resistor R18, and a voltage signal is acquired by the resistor R18. The output voltage at the transformer T1 increases, and the power delivered to the control module increases (current remains constant, voltage increases). The power information is fed back to the control module, and the control module promptly handles power abnormalities.

In this embodiment, please refer to FIG. 1. The output voltage feedback module includes a resistor R10, a resistor R16, and a capacitor C11. One terminal of the resistor R10 is connected to an anode of the diode D9 and a fourth terminal of the transformer T1. A fifth terminal of the transformer T1 is grounded. A cathode of the diode D9 is connected to one terminal of the resistor R6. The other terminal of the resistor R6 is connected to one terminal of the capacitor C7 and the current compensation module. The other terminal of the capacitor C7 is grounded. The other terminal of the resistor R10 is connected to one terminal of the resistor R16, one terminal of the capacitor C11, and the control module. The other terminal of the capacitor C11 is grounded. The other terminal of the resistor R16 is grounded.

The voltage information output by the voltage output module to the LED lamp is acquired through the voltage information of the fourth terminal and the fifth terminal of the transformer T1. The voltage of the fourth terminal and the fifth terminal of the transformer T1 serves as the sampled voltage. The resistors R10 and R16 divide the voltage. The voltage across the resistor R16 is filtered by the capacitor C11 and output to the control module. The control module acquires the output voltage information to maintain a low output no-load voltage and output overvoltage protection.

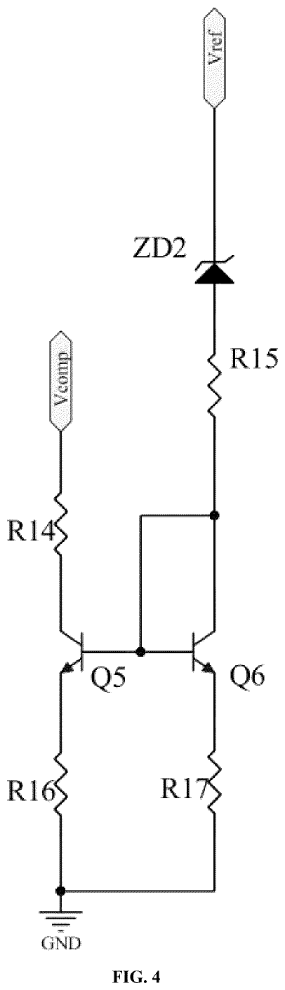

In this embodiment, please refer to FIGS. 1 and 4. The current compensation module includes a diode ZD2, a resistor R15, a transistor Q5, a transistor Q6, and a resistor R14. A cathode of the diode ZD2 is connected to the output voltage feedback module. An anode of the diode ZD2 is connected to one terminal of the resistor R15. The other terminal of the resistor R15 is connected to a base of the transistor Q5, a base of the transistor Q6, and a collector of the transistor Q6. An emitter of the transistor Q6 is directly grounded or grounded through a resistor. An emitter of the transistor Q5 is directly grounded or grounded through a resistor. A collector of the transistor Q5 is connected to one terminal of the resistor R14. The other terminal of the resistor R14 is connected to the control module.

The transistors Q5 and Q6 are two transistors with identical characteristics. Since the collector (c) and base (b) of transistor Q6 are connected, Uce=Ube, i.e., the transistor Q6 operates in an amplification state. Assuming a current amplification coefficient is β, a collector current Ic=β*Ib. The bases (b) and emitters (e) of the transistors Q5 and Q6 are connected, so the base currents of the transistors Q5 and Q6 satisfy Ib5=Ib6=Ib, and the collector currents of the two transistors satisfy IC_{Q5}=IC_{Q6}=Ic=β*Ib. Due to this special circuit connection, the collector currents IC_{Q4} and IC_{Q5} exhibit a mirror relationship. Thus, this circuit is referred to as a mirror constant-current source.

The diode ZD2 is a 7.5-12 V voltage regulator diode. The processed voltage VREF at the auxiliary winding (T1-B) of the transformer T1 is acquired. The auxiliary winding voltage is proportionally mapped to the output load voltage, with the proportionality coefficient n being a turns ratio of the transformer windings N2:N3.

For example, the voltage signal of VREF increases as the LED load voltage rises. The current flowing through the base of the transistor Q6 increases. According to the working principle of the mirror current source, the current flowing through the resistor R14 from the transistor Q5 increases. The divided voltage signal between the resistors R13 and R14 attenuates much, and the signal entering a pin 11 (FISNS pin) of a chip U1 decreases. The chip U1 increases the PWM duty cycle output at a pin 10 (FDRV pin) of the chip U1 through internal negative feedback based on the current signal to enhance output current, thereby maintaining a stable current on the LED load and avoiding fluctuations caused by output load variations.

In another embodiment, constructing similar functional circuits by appropriately adding or reducing resistors in the current compensation module still falls within the scope of the present disclosure, as its inventive spirit remains equivalent and is entitled to protection.

In another embodiment, constructing similar functional circuits by replacing the transistors Q5 and Q6 with other types of switching devices in the current compensation module still falls within the scope of the present disclosure, as its inventive spirit remains equivalent and is entitled to protection.

In another embodiment, constructing similar functional circuits by appropriately changing the zener voltage of the voltage regulator diode ZD2 in the current compensation module still falls within the scope of the present disclosure, as its inventive spirit remains equivalent and is entitled to protection.

In this embodiment, please refer to FIG. 1. The control module includes the chip U1. The model of the chip U1 is IW3617 or IW3616. A pin 7 of the chip U1 is connected to the power supply module. A pin 2 of the chip U1 is connected to the input undervoltage and overvoltage protection module. A pin 6 of the chip U1 is connected to the high-voltage startup module. A pin 4 and a pin 10 of the chip U1 are connected to the BOOST module. A pin 11 of the chip U1 is connected to the over-power protection module and the current compensation module. A pin 12 of the chip U1 is connected to the output voltage feedback module.

The chip U1 comprehensively controls circuit operation, and its model can be selected as IW3617 or IW3616.

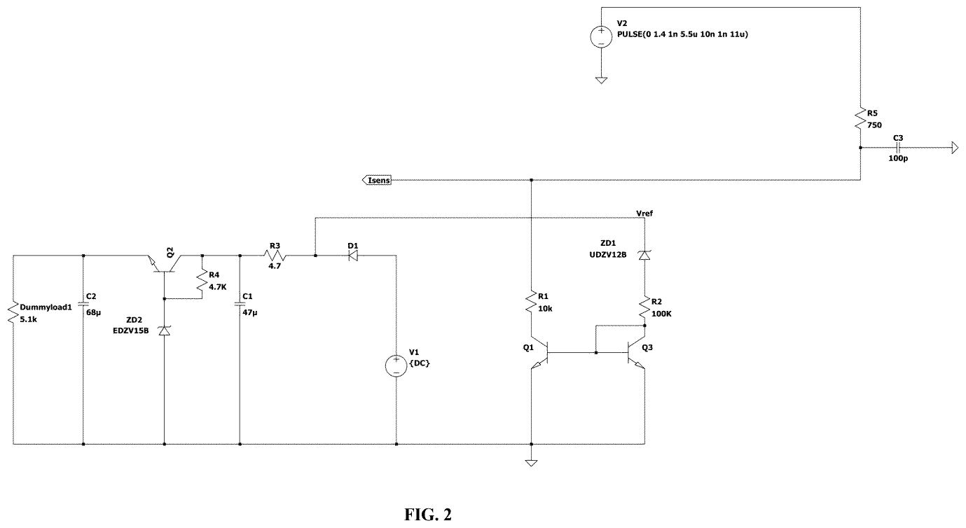

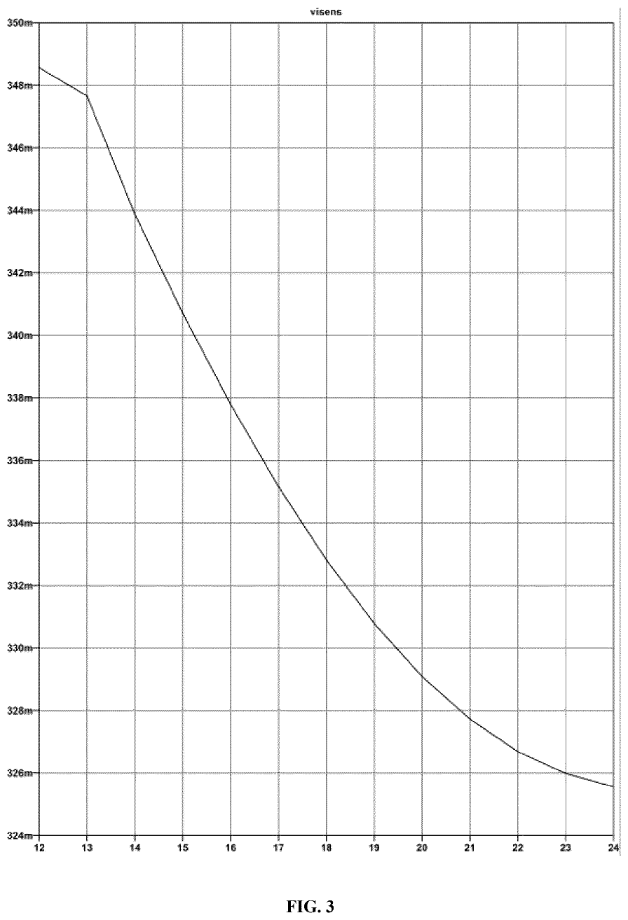

Please refer to FIGS. 2 and 3. To provide a clearer illustration, a simulated circuit diagram is established, as shown in FIG. 2. According to a simulated waveform in FIG. 3, the circuit starts operating when the VREF signal reaches approximately 12 V, and the FISNS signal (vertical axis) begins to decrease following the VREF signal.

The physical test data is shown in the table below:

| | | Iout (mA) output current | |
|---|---|---|---|
| | | Without an | With the |
| | | optimization | optimization |
| Vout (V) | Vref (V) | circuit | circuit |
| 20 | 11.6 | 169 | 165 |
| 22 | 12.8 | 167 | 166 |
| 24 | 13.9 | 166 | 166 |
| 26 | 15.0 | 164 | 166 |
| 28 | 16.2 | 162 | 166 |
| 30 | 17.4 | 160 | 165 |
| 32 | 18.6 | 157 | 165 |
| 34 | 19.8 | 155 | 165 |
| 36 | 20.9 | 153 | 164 |
| 38 | 22.1 | 152 | 163 |
| 40 | 23.3 | 151 | 163 |

| | | |
|---|---|---|
| Load regulation positive deviation | 5.87% | 0.66% |
| Load regulation negative | −5.41% | −1.16% |
| deviation | | |
| Load regulation total deviation | 11.28% | 1.82% |

In the prior art, output current variations caused by LED load variations (voltage variations at the LED load) result in significant power errors and brightness fluctuations. As shown in the table above, after the present disclosure is applied, the load regulation is optimized from 11.28% to 1.82%, demonstrating remarkable improvement.

The working principle of the present disclosure is as follows. The voltage input module is configured to convert an AC into a DC for output. The input undervoltage and overvoltage protection module is configured to detect a voltage condition of the voltage input module and provide a feedback to the control module. The high-voltage startup module is configured to provide a startup voltage to the control module during circuit startup. The BOOST module is configured to receive a control from the control module, boost the DC output from the voltage input module, and output a voltage to the voltage output module. The over-power protection module is configured to detect an output power of the BOOST module and provide a feedback to the control module. The voltage output module is configured to receive the voltage output from the BOOST module, process the voltage, and supply a DC to the LED load. The output voltage feedback module is configured to sample a voltage of the voltage output module and provide a feedback to the control module. The current compensation module is configured to change signal magnitude fed back to the control module when the voltage sampled by the output voltage feedback module reaches a startup value, thereby changing a duty cycle of a driving output through the control module to ultimately stabilize a current flowing through the LED load. The power supply module is configured to provide an operating voltage for the control module. The control module is configured to comprehensively control circuit operation.

It is apparent for those skilled in the art that the present disclosure is not limited to details of the above exemplary embodiments, and that the present disclosure may be implemented in other specific forms without departing from spirit or basic features of the present disclosure. The embodiments should be regarded as exemplary and non-limiting in every respect.

In addition, it should be understood that although this specification is described in accordance with the implementations, not each implementation only contains an independent technical solution, and this description in the specification is only for clarity. Those skilled in the art should take the specification as a whole. The technical solutions in the embodiments can also be properly combined to form other implementations that can be understood by those skilled in the art.

What is claimed is:

1. A load regulation optimization circuit for a wide-load light-emitting diode (LED) driver power supply, comprising:
a voltage input module, configured to convert an alternating current (AC) into a direct current (DC) for output;
an input undervoltage and overvoltage protection module, configured to detect a voltage of the voltage input module and provide a feedback to a control module;
a high-voltage startup module, configured to provide a startup voltage to the control module during circuit startup;
a BOOST module, configured to receive a control from the control module, boost the DC output from the voltage input module, and output a voltage to a voltage output module;
an over-power protection module, configured to detect an output power of the BOOST module and provide a feedback to the control module;
the voltage output module, configured to receive the voltage output from the BOOST module, process the voltage, and supply a DC to an LED load;
an output voltage feedback module, configured to sample a voltage of the voltage output module and provide a feedback to the control module;
a current compensation module, configured to change signal magnitude fed back to the control module when the voltage sampled by the output voltage feedback module reaches a startup value, thereby changing a duty cycle of a driving output through the control module to ultimately stabilize a current flowing through the LED load;
a power supply module, configured to provide an operating voltage for the control module; and
the control module, configured to comprehensively control circuit operation;
wherein, the voltage input module is connected to the input undervoltage and overvoltage protection module, the high-voltage startup module, and the BOOST module; the input undervoltage and overvoltage protection module is connected to the control module; the high-voltage startup module is connected to the control module; the BOOST module is connected to the over-power protection module, the voltage output module, and the output voltage feedback module; the over-power protection module is connected to the control module; the output voltage feedback module is connected to the control module and the current compensation module; the current compensation module is connected to the control module; and the power supply module is connected to the control module; and
the current compensation module comprises a diode ZD2, a resistor R15, a transistor Q5, a transistor Q6, and a resistor R14; the diode ZD2 comprises a cathode connected to the output voltage feedback module and an anode connected to one terminal of the resistor R15; another terminal of the resistor R15 is connected to a base of the transistor Q5, a base of the transistor Q6, and a collector of the transistor Q6; an emitter of the transistor Q6 is directly grounded or grounded through a resistor; an emitter of the transistor Q5 is directly grounded or grounded through a resistor; a collector of the transistor Q5 is connected to one terminal of the resistor R14; and the other terminal of the resistor R14 is connected to the control module.

2. The load regulation optimization circuit according to claim 1, wherein the input undervoltage and overvoltage protection module comprises a diode D6, a diode D8, a resistor R7, and a capacitor C8; an anode of the diode D6 is connected to the voltage input module; an anode of the diode D8 is connected to the voltage input module; a cathode of the diode D6 is connected to a cathode of the diode D8 and one terminal of the resistor R7; the other terminal of the resistor R7 is connected to one terminal of the capacitor C8 and the control module; and the other terminal of the capacitor C8 is grounded.

3. The load regulation optimization circuit according to claim 1, wherein the high-voltage startup module comprises a resistor R3, a resistor R5, a transistor Q2, and a diode D7; one terminal of the resistor R3 is connected to one terminal of the resistor R5 and the voltage input module; the other terminal of the resistor R3 is connected to a collector of the transistor Q2; the other terminal of the resistor R5 is connected to a base of the transistor Q2 and the control module; an emitter of the transistor Q2 is connected to an anode of the diode D7; and a cathode of the diode D7 is connected to the control module.

4. The load regulation optimization circuit according to claim 1, wherein the BOOST module comprises a transformer L1, a diode DI, a diode D2, a transistor Q1, a resistor R11, a resistor R2, a capacitor C10, a capacitor C2, a capacitor C1, a resistor R1, a diode D5, a metal-oxide-semiconductor (MOS) transistor Q4, and a resistor R12; a fourth terminal of the transformer L1 is connected to the voltage input module and an anode of the diode D1; a sixth terminal of the transformer L1 is connected to the control module through a resistor R8; a tenth terminal of the transformer L1 is grounded; a first terminal of the transformer L1 is connected to a collector of the transistor Q1 and an anode of the diode D2; an emitter of the transistor Q1 is connected to one terminal of the resistor R11 and the control module; the other terminal of the resistor R11 is grounded; a base of the transistor Q1 is connected to the control module; a cathode of the diode D1 is connected to a cathode of the diode D2, one terminal of the resistor R2, one terminal of the capacitor C2, one terminal of the capacitor C1, one terminal of the resistor R1, and a first terminal of a transformer T1; the other terminal of the resistor R2 is connected to the control module and one terminal of the capacitor C10; the other terminal of the capacitor C10 is grounded; the other terminal of the capacitor C2 is grounded; the other terminal of the capacitor C1 is connected to the other terminal of the resistor RI and a cathode of the diode D5; an anode of the diode D5 is connected to a third terminal of the transformer T1 and a drain (D) of the MOS transistor Q4; a source (S) of the MOS transistor Q4 is connected to the over-power protection module; and a gate (G) of the MOS transistor Q4 is connected to the control module through the resistor R12.

5. The load regulation optimization circuit according to claim 1, wherein the over-power protection module comprises a resistor R18, a resistor R13, and a capacitor C12; one terminal of the resistor R18 is connected to one terminal of the resistor R13 and the BOOST module; the other terminal of the resistor R18 is grounded; the other terminal of the resistor R13 is connected to the control module and one terminal of the capacitor C12; and the other terminal of the capacitor C12 is grounded.

6. The load regulation optimization circuit according to claim 1, wherein the output voltage feedback module comprises a resistor R10, a resistor R16, and a capacitor C11; one terminal of the resistor R10 is connected to an anode of the diode D9 and a fourth terminal of a transformer T1; a fifth terminal of the transformer T1 is grounded; a cathode of a diode D9 is connected to one terminal of a resistor R6; the other terminal of the resistor R6 is connected to one terminal of a capacitor C7 and the current compensation module; the other terminal of the capacitor C7 is grounded; the other terminal of the resistor R10 is connected to one terminal of the resistor R16, one terminal of the capacitor C11, and the control module; the other terminal of the capacitor C11 is grounded; and the other terminal of the resistor R16 is grounded.

7. The load regulation optimization circuit according to claim 1, wherein the control module comprises a chip U1, and a model of the chip U1 is IW3617 or IW3616; a pin 7 of the chip U1 is connected to the power supply module; a pin 2 of the chip U1 is connected to the input undervoltage and overvoltage protection module; a pin 6 of the chip U1 is connected to the high-voltage startup module; a pin 4 and a pin 10 of the chip U1 are connected to the BOOST module; a pin 11 of the chip U1 is connected to the over-power protection module and the current compensation module; and a pin 12 of the chip U1 is connected to the output voltage feedback module.
